(19) United States
(12) Patent Application Publication
(10) Pub. No.: US 2004/0137893 A1
(43) Pub. Date: Jul. 15, 2004

(54) Communication system for information security and recovery and method therfor

(76) Inventors: Sivakumar Muthuswamy, Plantation, FL (US); Anupama Ramamurthy, Plantation, FL (US)

Correspondence Address: Randi L. Dulaney, Motorola, Inc., Law Department, 8000 West Sunrise Boulevard, Fort Lauderdale, FL, 33322, US

(21) Appl. No.: 10/342,980

(22) Filed: Jan. 15, 2003

(51) Int. Cl. H04M 3/00

(52) U.S. Cl. 455/419; 455/418

(57) ABSTRACT

A communication system (10) for information security and recovery includes at least one communication device (60) having a memory (145) for storing a plurality of device information (117); a backup server (110); and a system controller (40) coupled between the backup server (110) and the at least one communication device (60). The system controller (40) is programmed to receive a request to secure the communication device (60); transfer the plurality of device information (117) from the communication device (60) to the backup server (110); and disable the operation of the communication device (60).

### BACKGROUND OF THE INVENTION

1. Field of the Invention

This invention relates in general to communication systems and more particularly to communication systems having information security capability.

2. Description of the Related Art

As technology continues to enhance the utility and value of wireless communication devices, such as cellular telephones and two-way messaging devices, theft of such devices also continues to increase. For example, a recent news article reported that thefts of cellular telephones in the United Kingdom have more than doubled in the past year.

Service providers have been responding to the increased thefts by implementing security mechanisms, which disable the account and/or SIM card of a reportedly stolen communication device to prevent that particular account from being utilized by another. One drawback to this approach is that the stolen communication device can still be reprogrammed and/or a new SIM card installed which allows full utilization of the device on the same or a different communication system. A second drawback is that if the communication device is recovered, all related information stored in the memory may be lost to the valid user.

New technologies are currently being developed which could be used to disable stolen communication devices by “blowing up” silicon chips in the devices using an electrical signal sent over the communication channel of the communication system. Self-destroying chips render the stolen device completely inoperable. This solves the drawback of the thieves reprogramming and reusing the device. However, rendering the stolen device inoperable can be a drawback if the device is recovered.

Recently, solutions have been developed which allow remote disabling of the keypad of a stolen device to render it inoperable without completely destroying the functionality and data of the device. When returned to its owner, the device can be reprogrammed to enable the keypad again. One drawback of this solution is that if the device is not recovered, the device owner has lost all information stored within it. A second drawback is the potential for thieves to re-enable the keypad through various means and then have full functionality of the device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electronic block diagram of a communication system in accordance with a preferred embodiment of the present invention.

FIG. 2 illustrates one example of a plurality of device information for use within the communication system of FIG. 1 in accordance with a preferred embodiment of the present invention.

FIG. 3 is an electronic block diagram of a communication device for use within the communication system of FIG. 1 in accordance with a preferred embodiment of the present invention.

FIGS. 4 and 5 are flowcharts illustrating various embodiments of the operation of the communication system of FIG. 1 in accordance with the present invention.

### DETAILED DESCRINTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

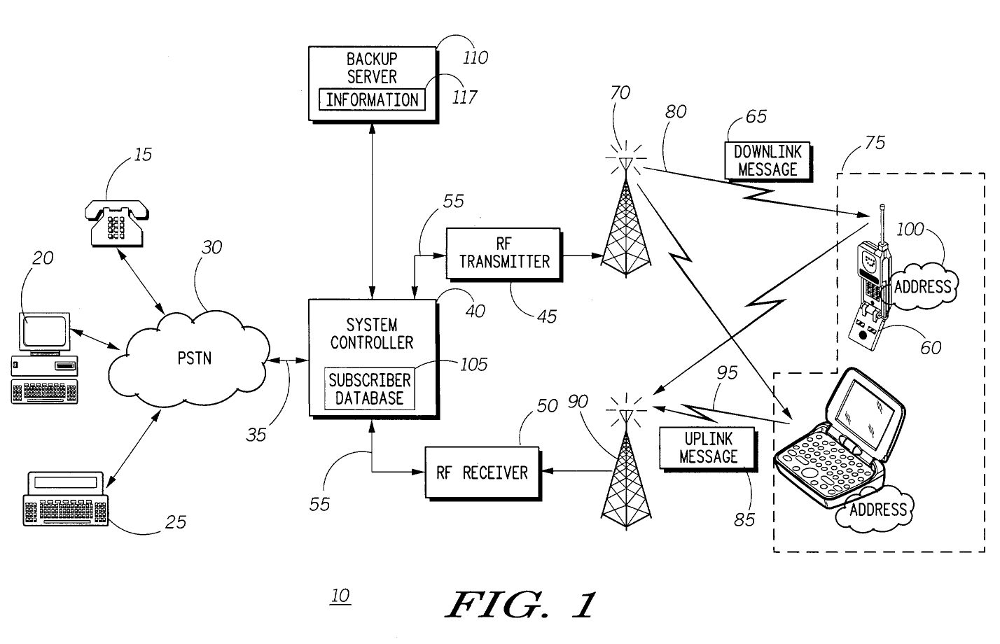

Referring to FIG. 1, an electronic block diagram of a communication system 10 for information security and recovery is shown. The communication system 10 includes a message input device for initiating messages into the communication system 10. The message input device can be, for example, a telephone 15, a computer 20, or a desktop messaging unit 25, connected through a conventional public switched telephone network (PSTN) 30 through a plurality of telephone links 35 to a system controller 40. The telephone links 35, for example, can be a plurality of twisted wire pairs, a fiber optic cable, or a multiplexed trunk line.

The system controller 40 is coupled to and oversees the operation of at least one radio frequency (RF) transmitter 45 and at least one radio frequency (RF) receiver 50 through one or more communication links 55. The communication links 55 typically are twisted pair telephone wires, and additionally can include radio frequency (RF), microwave, or other communication links. The radio frequency transmitter 45 and the radio frequency receiver 50 typically are used with message store and forward stations that encode and decode inbound and outbound messages into formats that are compatible with landline message switched computers and personal radio addressing requirements, such as cellular messages, short messaging service, or paging protocols. The system controller 40 can also function to encode and decode wireless messages that are transmitted to or received by the radio frequency transmitter 45 or the radio frequency receiver 50. Telephony signals are typically transmitted to and received from the system controller 40 by telephone sets such as the telephone 15 or a communication device 60. The system controller 40 encodes and schedules outbound messages such as a downlink message 65. The system controller 40 then transmits the encoded outbound messages through the radio frequency transmitter 45 via a transmit antenna 70 to one or more of a plurality of communication devices 75 such as the communication device 60 on at least one outbound radio frequency (RF) channel 80. The downlink message 65 can be, for example, a data message or a voice call. Similarly, the system controller 40 receives and decodes inbound messages such as an uplink message 85 received by the radio frequency receiver 50 via a receive antenna 90 on at least one inbound radio frequency (RF) channel 95 from one of the plurality of communication devices 75. The uplink message 85 can be, for example, a data message, a reply to a data message, a voice call, or a reply to a voice call.

It will be appreciated by one of ordinary skill in the art that the communication system 10, in accordance with the present invention, can be a wireless communication system, a wired communication system, a broadcast communication system, or any other equivalent communication system. For example, the communication system 10 can function utilizing any wireless RF channel, for example, a one or two-way messaging channel, a mobile cellular telephone channel, or a mobile radio channel. Similarly, it will be appreciated by one of ordinary skill in the art that the communication system 10 can function utilizing other types of communication channels such as infrared channels and/or Bluetooth channels. Further, it will be appreciated by one of ordinary skill in the art that the communication system 75 can function utilizing a wireline communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or between the devices and the shared resources. The WAN, for example, can use a physical network media such as X.25, Frame Relay, ISDN, Modem dial-up or other media to connect devices or other local area networks. In the following description, the term “communication system” refers to any of the systems mentioned above or an equivalent.

Similarly, it will be appreciated by one of ordinary skill in the art that each of the plurality of communication devices 75, such as the communication device 60, in accordance with the present invention, can be a wireless communication device, a wired communication device, a broadcast communication device, or any other equivalent communication device. For example, the communication device can be a mobile cellular telephone, a mobile radio data terminal, a mobile cellular telephone having an attached or integrated data terminal, or a two-way messaging device. Similarly, the communication device can be any other electronic device such as a personal digital assistant or a laptop computer, which can be remotely accessed, controlled and backed up by an authorized entity. In the following description, the term “communication device” refers to any of the devices mentioned above or an equivalent.

Each of the plurality of communication devices 75 assigned for use in the communication system 10 has an address or identity assigned thereto which is a unique selective call address in the communication system 10. For example, the communication device 60 assigned for use in the communication system 10 has an address 100 assigned thereto which is a unique selective call address in the communication system 10 for the communication device 60. The address 100 enables the transmission of the downlink message 65 from the system controller 40 only to the communication device 60 having the address 100, and identifies the messages and responses received at the system controller 40 from the communication device 60 with the address 100. In one embodiment, each of the plurality of communication devices 75 also has a pin number assigned thereto, the pin number being associated with a telephone number within the PSTN 30. A list of the assigned addresses and correlated telephone numbers for each of the plurality of communication devices 75 is stored in the system controller 40 in the form of a subscriber database 105.

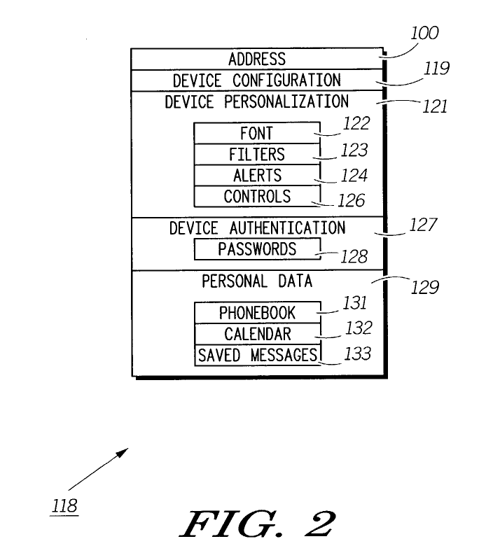

Preferably, and in accordance with the present invention, the communication system 10 includes a backup server 110 coupled to the system controller 40. The backup server 110 receives and stores a plurality of information 117 associated with each of the plurality of communication devices 75. FIG. 2 illustrates one example of a plurality of device information 118 of the plurality of information 117 for the communication device 60. As illustrated, the plurality of device information 118 can include the address 100, a device configuration 119, a plurality of device personalization information 121, a device authentication data 127 such as a password 128, a plurality of personal data 129, and the like. The plurality of device personalization 121, for example, can include a plurality of font attributes 122, a plurality of filter settings 123, a plurality of alert settings 124, and a plurality of control settings 126, and the like. The plurality of personal data 129 can include, for example, a phonebook 131, a calendar 132, and a plurality of saved messages 133.

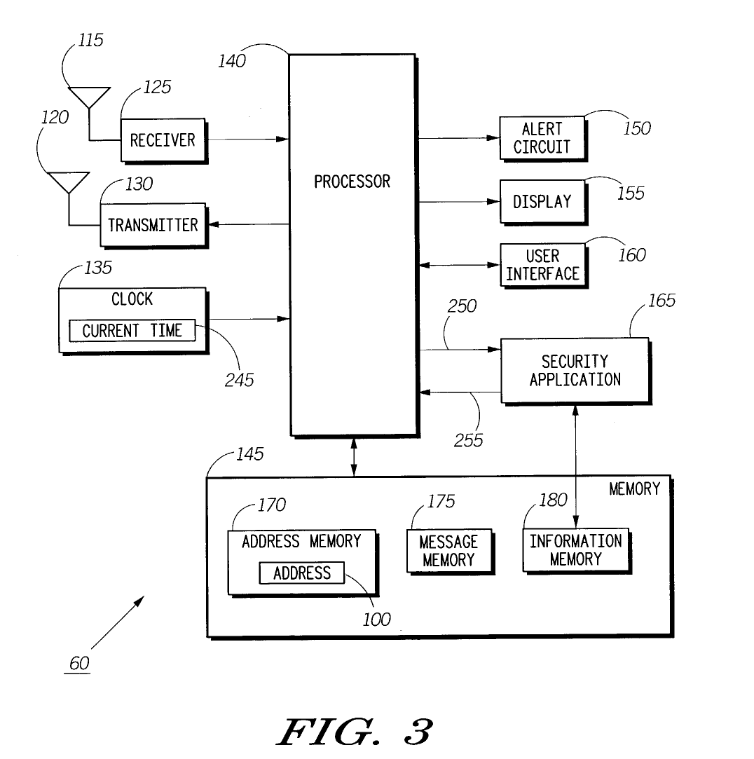

FIG. 3 is an electronic block diagram of a preferred embodiment of the communication device 60 for use within the communication system 10 of FIG. 1 in accordance with the present invention. It will be appreciated by one of ordinary skill in the art that the electronic block diagram of FIG. 3 is illustrative of each of the plurality of communication devices 75 assigned for use in the communication system 10.

Referring to FIG. 3, the communication device 60 includes a first antenna 115, a second antenna 120, a receiver 125, a transmitter 130, a clock 135, a processor 140, a memory 145, an alert circuit 150, a display 155, a user interface 160, and a security application 165. It will be appreciated by one of ordinary skill in the art that the security application 165 can be a software program or any other equivalent.

The first antenna 115 intercepts transmitted signals from the communication system 10. The first antenna 115 is coupled to the receiver 125, which employs conventional demodulation techniques for receiving the communication signals transmitted by the communication system 10 such as the downlink message 65 of FIG. 1.

Coupled to the receiver 125, is the processor 140 utilizing conventional signal-processing techniques for processing received messages. Preferably, the processor 140 is similar to the MC68328 micro-controller manufactured by Motorola, Inc. of Schaumburg, Ill. It will be appreciated by one of ordinary skill in the art that other similar processors can be utilized for the processor 140, and that additional processors of the same or alternative type can be utilized as required to handle the processing requirements of the processor 140.

The processor 140 decodes an address in the demodulated data of the received message, compares the decoded address with one or more addresses such as the address 100 stored in an address memory 170 of the memory 145; and when a match is detected, proceeds to process the remaining portion of the received message.

To perform the necessary functions of the communication device 60, the processor 140 is coupled to the memory 145, which preferably includes a random access memory (RAM), a read-only memory (ROM), and an electrically erasable programmable read-only memory (EEPROM)(not shown). The memory 145 is comprised of the address memory 170, a message memory 175, and an information memory 180. The information memory 180 preferably stores the plurality of device information 118 as illustrated in FIG. 2 for the communication device 60.

Once the processor 140 has processed a received message, it stores the decoded message in the message memory 175. It will be appreciated by one of ordinary skill in the art that the message memory 175, in accordance with the present invention, can be a voicemail box or a group of memory locations in a data storage device. In the following description, the term “message memory” refers to any of the memory means mentioned above or an equivalent.

Upon receipt and processing of a message, the processor 140 preferably generates a command signal to the alert circuit 150 as a notification that the message has been received and stored. The alert circuit 150 can include a speaker (not shown) with associated speaker drive circuitry capable of playing melodies and other audible alerts, a vibrator (not shown) with associated vibrator drive circuitry capable of producing a physical vibration, or one or more LEDs (not shown) with associated LED drive circuitry capable of producing a visual alert. It will be appreciated by one of ordinary skill in the art that other similar alerting means as well as any combination of the audible, vibratory, and visual alert outputs described can be used for the alert circuit 150.

Upon receipt of a message, the processor 140 preferably also generates a command signal to the display 155 to generate a visual notification of the receipt and storage of the message. When the display 155 receives the command signal from the processor 140 that the message has been received and stored in the message memory 175, a message indication is displayed. The message indication, for example can be the activation of one of a plurality of message icons on the display 155. The display 155 can be, for example, a liquid crystal display, a dot matrix display, or an equivalent.

The communication device 60 preferably further includes the clock 135. The clock 135 provides timing for the processor 140. The clock 135 preferably includes a current time 245 for use in the operation of the communication device 60 such as for use by the security application 165. The clock 135 also provides a source for timing of feature enhancements such as active and inactive periods of operation or periods of alerting.

In a preferred embodiment, the communication device 60 includes the security application 165. The security application 165 is programmed to process one or more security messages received by the receiver 125 to provide secure functionality to the communication device 60. The security application 165 can be hard coded or programmed into the communication device 60 during manufacturing, can be programmed over-the-air upon customer subscription, or can be a downloadable application. It will be appreciated by one of ordinary skill in the art that other programming methods can be utilized for programming the security application 165 into the communication device 60.

The security application 165, in response to the receipt by the communication device 60 of a message including a security notification preferably accesses the information memory 180 of the memory 145. The security application 165 is programmed with a set of rules identifying operations to perform in response to receipt of security notifications. For example, the security application 165 can initiate the transfer of the plurality of device information 118 from the information memory 180 to the backup server 110 in response to receiving a first security notification. Alternatively, the security application 165 can initiate the complete erasure of the plurality of device information 118 from the information memory 180 in response to a second security notification. In a preferred embodiment, the security application 165 operates in a manner that is non-obtrusive to the device user. For example, when the communication device 60 is stolen, preferably the thief is not notified of the operation of the security application 165. Similarly, upon receipt of a security re-enablement message, the security application 165 can authorize the restoring of the plurality of device information 118 received from the backup server 110 into the information memory 180.

The security application 165, in accordance with the present invention, provides a method of securing and recovering the configuration, password and personal data stored in a stolen/lost phone. The invention leverages the ability of over-the-air control and data transfer features available in most communication devices today to provide beneficial security and recovery.

Preferably, the user interface 160 is coupled to the processor 140, as shown in FIG. 3. The user interface 160 can be one or more buttons used to generate a button press, a series of button presses, a voice response from the device user, or some other similar method of manual response initiated by the device user of the wireless communication device 60.

The transmitter 130 is coupled to the processor 140 and is responsive to commands from the processor 140. When the transmitter 130 receives a command from the processor 140, the transmitter 130 sends a signal via the second antenna 120 to the communication system 10. The signal, for example, can be the uplink message 85. (see FIG. 1). For example, when the security application 165 initiates the transmitting of the plurality of device information 118 to the backup server 110, the transmitter 130 sends one or more messages including the plurality of device information 118.

In an alternative embodiment (not shown), the communication device 60 includes one antenna performing the functionality of the first antenna 115 and the second antenna 120. Further, the communication device 60 alternatively includes a transceiver circuit performing the functionality of the receiver 125 and the transmitter 130. It will be appreciated by one of ordinary skill in the art that other similar electronic block diagrams of the same or alternate type can be utilized for the communication device 60 to handle the requirements of the communication device 60.

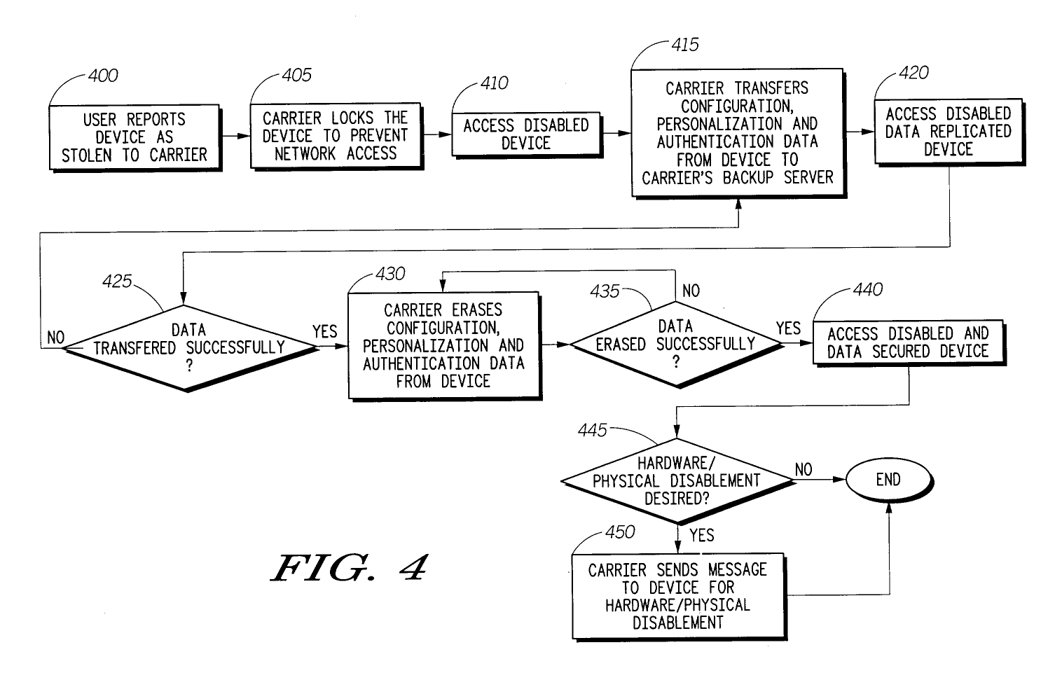

FIG. 4 is a flowchart illustrating one embodiment of the operation of the communication system 10 for information security and recovery of FIG. 1 in accordance with the present invention. The process begins with Step 400 in which a user reports his communication device as stolen. For example, the user can call the service provider or carrier operating the communication system 10 to report that the communication device 60 operating within the communication system 10 was stolen or lost. Step 400 preferably includes a request to secure a communication device that has been stolen, lost, or for any other equivalent reason. Next, in Step 405, once the communication device 60 is reported stolen or lost, access to the communication system 10 by the communication device 60 is locked (i.e. disabled) to prevent unauthorized use of the service(s) of the communication system 10. Methods and procedures for disabling access to networks are well known in the art and the method according to the present invention complements and supplements those methods. Next, in Step 410, the service provider accesses the disabled device to obtain the desired device information. For example, the service provider can communicate a message to the communication device 60 including a first security notification requesting the communication device 60 to transmit the plurality of device information 118 stored in the information memory 180. The security application 165 can process this request and the plurality of device information 118 can be transmitted using the transmitter 130. Next, in Step 415, the service provider completes the transfer of the desired information received from the stolen device to its backup server. For example, the plurality of device information 118 can be stored within the backup server 110 of the communication system 10. This step is preferably carried out discreetly without any warnings or signs on the communication device. Next, in Step 420, the transferred device information is now accessible from the backup server. For example, the user can access the transferred device information for utilization directly or on another device. Similarly, the user can copy the transferred device information to another device. In Step 425, the service provider determines whether the data transfer was successful. When the data transfer is not successful in Step 425, the process returns to Step 415 and the transfer operation performed again. In Step 430, when the data transfer is successfully completed in Step 425, the carrier initiates the step of erasing substantially all of the information stored on the communication device. Next, in Step 435, the carrier determines whether the data erasure operation of Step 430 was successful. When the data erasure is not successful in Step 430, the process returns to the data erasure Step 430. In Step 440, when the data erasure is successful, the device's access to the communication system is resultantly disabled and the data that was in the device is secured from unauthorized access. Next, in Step 445, it is determined whether hardware operation and/or physical disablement of the device are desired. When hardware and/or physical disablement of the device are not desired, the process ends. In Step 450, when hardware and/or physical disablement of the device are desired, the carrier sends (communicates) a message including a second security notification having a request to the communication device to disable the communication device hardware, software, and/or any other subset of the operation of the communication device. Methods of hardware/physical disablement known in the art can be implemented in Step 450. The process then ends. The plurality of device information 118 is now available to be reprogrammed into a replacement device, into the original device when relocated, or utilized directly for other operations. (not shown)

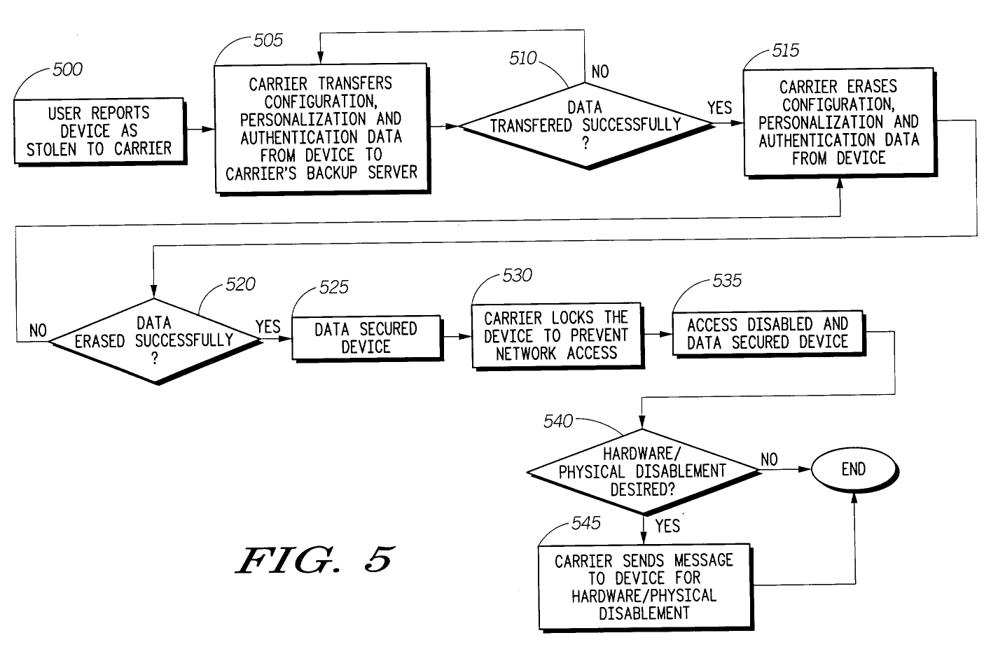

FIG. 5 is a flowchart illustrating an alternative embodiment of the operation of the communication system 10 for information security and recovery of FIG. 1 in accordance with the present invention. In the embodiment shown in FIG. 5, the step of disabling access to the network is done after the data backup and erasure steps are completed. Using this method, the carrier is more likely to be able to locate and discreetly access the phone for backup and securing sensitive data, especially in the case of stolen phones. The process begins with Step 500 in which a user reports his communication device as stolen. For example, the user can call the service provider or carrier operating the communication system 10 to report that the communication device 60 was stolen or lost. Next, in Step 505, the service provider transfers the desired information received from the stolen device to its backup server. For example, the plurality of device information 118 can be stored within the backup server 110 of the communication system 10. This step is preferably carried out discreetly without any warnings or signs on the communication device. Next, in Step 510, the service provider determines whether the data transfer was successful. When the data transfer is not successful in Step 510, the process returns to Step 505 and the transfer operation performed again. In Step 515, when the data transfer is successfully completed in Step 510, the carrier initiates the step of erasing substantially all of the information stored on the communication device. Next, in Step 520, the carrier determines whether the data erasure operation of Step 515 was successful. When the data erasure is not successful in Step 520, the process returns to the data erasure Step 515. In Step 525, when the data erasure is successful, the stolen/lost device is now a data secured device. Next, in Step 530, the communication device 60 is locked to prevent unauthorized use of the service(s) of the communication system 10. Methods and procedures for disabling access to networks are well known in the art and the method according to the present invention complements and supplements those methods. Next, in Step 535, the device's access to the communication system is resultantly disabled and the data that was in the device is secured from unauthorized access. Next, in Step 540, it is determined whether hardware and/or physical disablement of the device are desired. When hardware and/or physical disablement of the device are not desired, the process ends. In Step 545, when hardware and/or physical disablement of the device are desired, the carrier sends a message to the communication device to disable the communication device hardware. Methods of hardware/physical disablement known in the art can be implemented in Step 545. The process then ends. The plurality of device information 118 is now available to be reprogrammed into a replacement device, into the original device when relocated, or utilized directly for other operations.

This invention will lead to a new class of security and recovery mechanisms that address a critical need in the communications industry. In addition to transaction security, successful rollout and consumer acceptance of m-commerce depends a great deal on the security and recovery options available to the user when a communication device is lost or stolen.

Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. A method for information security and recovery within a communication system having a plurality of communication devices and a backup server, the method comprising:
receiving a request to secure a communication device operating within the communication system;
transferring a plurality of device information from the communication device to the backup server; and
disabling the operation of the communication device.

2. The method for information security and recovery as recited in claim 1 further comprising:
disabling the communication device's access to the communication system prior to the transferring step.

3. The method for information security and recovery as recited in claim 1 wherein the transferring step comprises:
communicating a message including a first security notification to the communication device,

4. The method for information security and recovery as recited in claim 3 wherein the first security notification comprises a request for the communication device to transmit the plurality of device information.

5. The method of information security and recovery as recited in claim 3 wherein the transferring step further comprises:
transmitting the plurality of device information by the communication device in response to the first security notification.

6. The method of information security and recovery as recited in claim 5 wherein the transferring step further comprises:
storing the plurality of device information in the backup server in response to the transmitting step.

7. The method of information security and recovery as recited in claim 1 further comprising:
storing the plurality of device information within a memory of the communication device prior to the receiving a request step.

8. A method for information security and recovery as recited in claim 1 wherein the transferring step is carried out discreetly without any warnings or signs on the communication device.

9. A method for information security and recovery as recited in claim 1 further comprising:
accessing the plurality of device information stored in the backup server.

10. A method for information security and recovery as recited in claim 1 wherein the disabling operation comprises erasing the plurality of device information from a memory of the communication device.

11. A method for information security and recovery as recited in claim 1 wherein the disabling operation comprises physically disabling the hardware operation of the communication device.

12. A method for information security and recovery as recited in claim 1 wherein the disabling operation comprises physically disabling the communication device.

13. A method for information security and recovery as recited in claim 1 wherein the disabling operation comprises communicating a second security notification to the communication device including a request to disable the communication device.

14. A method for information security and recovery as recited in claim 1 further comprising:
reprogramming the plurality of device information into a replacement device.

15. A method for information security and recovery as recited in claim 1 further comprising:
reprogramming the plurality of device information into the communication device.

16. A method for information security and recovery as recited in claim 1 further comprising:
utilizing the plurality of device information directly for one or more other operations.

17. A communication system for information security and recovery comprising:
at least one communication device having a memory for storing a plurality of device information;
a backup server; and
a system controller coupled between the backup server and the at least one communication device, wherein the system controller is programmed to:
receive a request to secure the communication device;
transfer the plurality of device information from the communication device to the backup server; and
disable the operation of the communication device.

18. A communication system for information security and recovery as recited in claim 17 wherein the system controller is further programmed to disable the communication device's access to the communication system prior to the transfer step.

19. A communication system for information security and recovery as recited in claim 17 wherein the disabling of the operation of the communication device comprises erasing the plurality of device information from a memory of the communication device.

20. A communication system for information security and recovery as recited in claim 17 wherein the disabling of the operation of the communication device comprises physically disabling the hardware operation of the communication device.

21. A communication system for information security and recovery as recited in claim 17 wherein the disabling of the operation of the communication device comprises physically disabling the communication device.

22. A communication system for information security and recovery as recited in claim 17 wherein the disabling of the operation of the communication device comprises communicating a message to the communication device including a request to disable the communication device.
